(19) United States
(12) Patent Application Publication
(10) Pub. No.: US 2003/0103731 A1
(43) Pub. Date: Jun. 5, 2003

(54) Fiber optic cable conduit coupler and protective shield

(76) Inventor: Anand Vinayak Gogte, Pune (IN)

Correspondence Address: TESTA, HURWITZ & THIBEAULT, LLP, HIGH STREET TOWER, 125 HIGH STREET, BOSTON, MA, 02110, US

(21) Appl. No.: 10/010,621

(22) Filed: Dec. 3, 2001

(51) Int. Cl. G02B 6/38

(52) U.S. Cl. 385/70

(57) ABSTRACT

A coupling assembly and method for joining together lengths of fiber optic cable conduit. In one embodiment the coupling assembly has a compressible resilient split sleeve and at least one radially extending guard. The coupling assembly may be quickly installed in the field by hand in order to couple a first length of fiber optic conduit to a second length of fiber optic conduit. The coupling assembly prevents rodents and other animals from gaining access to the optical fiber within the conduits.

### FIELD OF THE INVENTION

The present invention relates generally to the field of conduit couplers and, more specifically, to fiber optic conduit couplers.

### BACKGROUND OF THE INVENTION

The installation of fiber optic cable is a costly endeavor. Fiber optic cable is typically placed within a length of conduit during its installation. The conduit protects the delicate fiber optic cables from the damaging effects of nature and the environment. Given the impracticality of transporting extremely long lengths of fiber optic cable conduit and the realities of differing site conditions during installation in the field, it is often necessary to couple together lengths of conduit.

Coupling together lengths of fiber optic containing conduit is often a time, labor, and financially intensive activity. Concrete is often used as a means of joining together lengths of conduit being installed underground. A concrete mixture is poured over the ends of two lengths of conduit to form a joint as it solidifies. This use of concrete results in a very crude joint that is not rodent proof. In addition, the use of concrete gives rise to long curing times and the need for skilled labor. Poorly coupled lengths of conduit provide access to rodents and other fauna which can result in the destruction of the cables within the conduit. The present invention addresses these issues.

### SUMMARY OF THE INVENTION

This invention relates to a protective shield and coupling assembly and a method for protectively coupling together lengths of fiber optic cable conduit. The shield and coupling assembly include a resilient split sleeve with a guard extending radially from the split sleeve. The split sleeve's ductile properties are selected so that the sleeve is reversibly compressible to ensure it is capable of returning substantially to its original shape when compression terminates. In one embodiment of the invention, low carbon steel is used to fabricate the sleeve and guard.

When compressed, the sleeve is reduced in diameter. It is this size reduction which allows for the coupling assembly's sleeve to be inserted into the end of a length of fiber optic conduit. The radially extended guard prevents the entire length of the compressed split sleeve from being fully inserted into the fiber optic cable conduit. This restriction on insertion has the further advantage of preventing the assembly from slipping inside the conduit during use and thereby permitting the ends of the conduits to become uncoupled.

Once the compressed sleeve has been inserted into a length of fiber optic cable conduit, to the extent allowable by the location of the guard on the split sleeve's surface, compression may be terminated. The cessation of compression allows the split sleeve to expand to substantially equal the internal diameter of the fiber optic cable conduit. This expansion causes the shield and coupling assembly to come into contact with the walls of the fiber optic cable conduit. The end of the coupling assembly, opposite the connected fiber optic cable conduit, may then be compressed and inserted into another length of conduit. This allows for two lengths of fiber optic cable conduit to be joined together.

Furthermore, the choice of the ductile, resilient, corrosive, and damage resistant properties of the material comprising the split sleeve enable compression of the coupler by hand as well as enhance its function as a protective shield. The protective shield feature of the coupling assembly derives from the ability of the sleeve to conform to the geometry of the conduit that it is coupling and the intrinsic strength of the sleeve. When a properly configured preferred embodiment of the invention is installed, the coupling assembly will protect the fiber optic cables from destruction by rodents and other animals without the use of sealants or other solidifiable material such as concrete. This protection from rodents is accomplished by the expanding sleeve substantially filling the diameter of the fiber optic cable conduit it is coupling. The expanded sleeve reduces the area between the sleeve and the conduit that might provide a means of access to the interior of the conduit. This prevents rodents from reaching the fiber optic cables within the conduit.

The configuration of the guard provides the additional benefit of being able to visually track the location of the joints between two lengths of fiber optic cable conduit. This is accomplished by the guard protruding above the line of the outermost diameter of the lengths of fiber optic cable conduit the coupling assembly is joining. In addition, the invention has the advantage of being able to quickly couple lengths of conduit as a result of not needing welds or any devices for its installation. This advantage derives from the material properties of the sleeve which facilitate quick compression by hand in the field.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1A is a perspective view of an embodiment of the invention in its uncompressed state;

FIG. 1B is a perspective view of an embodiment of the invention in its uncompressed state and with an annular guard;

FIG. 2 is a perspective view of an embodiment of the coupler assembly in its coupled partially compressed state within two conduit tubes; and

FIG. 3 is a perspective view of an embodiment of the invention in its partially compressed, partially coupled state within a conduit tube.

### DESCRIPTION OF PREFERRED EMBODIMENT

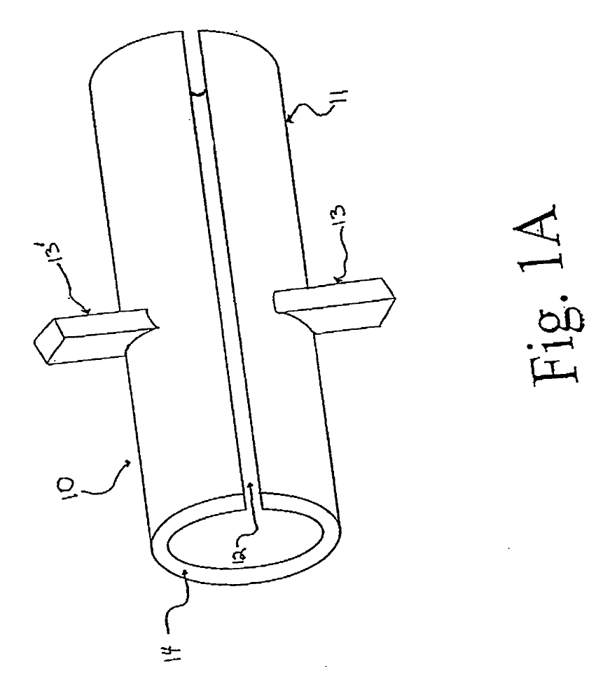

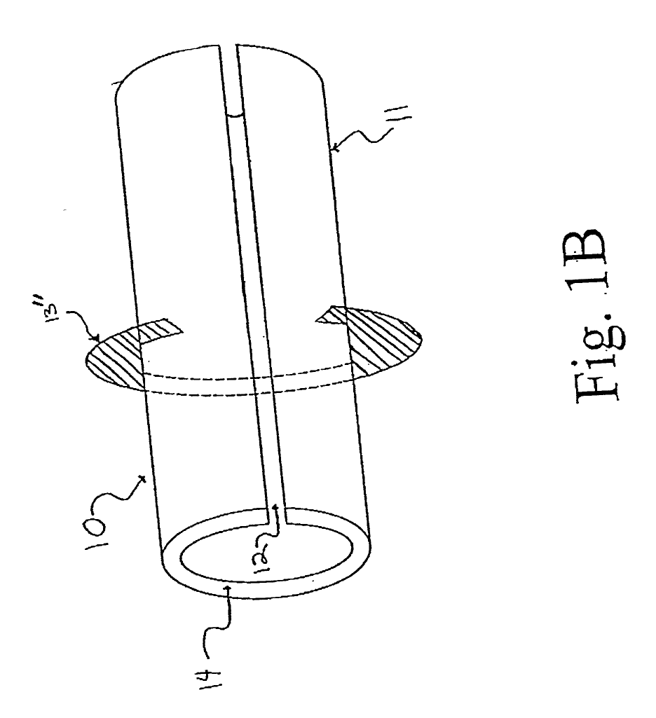

FIG. 1A illustrates a preferred embodiment of a protective shield and coupling assembly 10 for connecting two lengths of fiber optic conduit. The coupling assembly 10 is shown in its uncompressed uncoupled state. In this embodiment the coupling assembly 10 includes a resilient sleeve 11, having a slit 12 in the sleeve 11, and two guards 13, 13′ (generally 13) that are attached to and radiate radially outward from the sleeve 11. In another preferred embodiment of the invention, the resilient sleeve 11 and guard 13 are composed of low carbon steel. The length of each guard 13, 13′ and the thickness of the sleeve 14 are not shown in the proper proportions. That is, the length of the guard 13, as it extends perpendicularly from the surface of the sleeve 11, will generally exceed the sleeve thickness 14. Typically, the length of the guard 13 will be set in relation to the size of the sleeve 11 and the thickness of the conduit wall. In one preferred embodiment of the invention the thickness of the resilient sleeve 11 is approximately 1.5 mm. The guard 13 length and geometry will be chosen to allow the guard 13 to protrude above the top of the coupled fiber optic conduits. Thus the length of the guard 13 is typically greater than the thickness of the conduit wall. This is designed to allow the guard 13 to function as a visual cue for pointing out the locations of joints along the length of the installed coupled fiber optic conduits.

FIG. 1B illustrates another preferred embodiment of the guard 13″ attached to the coupling assembly 10. In this embodiment, the guard 13″ is a disk with an annular geometry from which a sector of the disk has been removed. The coupling assembly 10 is attached to the center circle of the annulus at the contact region between the sleeve 11 surface and the guard's 13″ center circle. The guard 13″ in this embodiment is bonded to the sleeve 11. The removal of the sector of the disk around the area of the split 12 prevents the guard 13″ from interfering with the sleeve's 11 movement when its undergoes compression and diameter size reduction. In other preferred embodiments, the guard 13″ is either chemically or mechanically attached to the sleeve 11. In one preferred embodiment of the invention, the ductile properties of the sleeve 11 are chosen so that the sleeve 11 is reversibly compressible to ensure it is capable of returning substantially to its original shape when compression by hand is terminated.

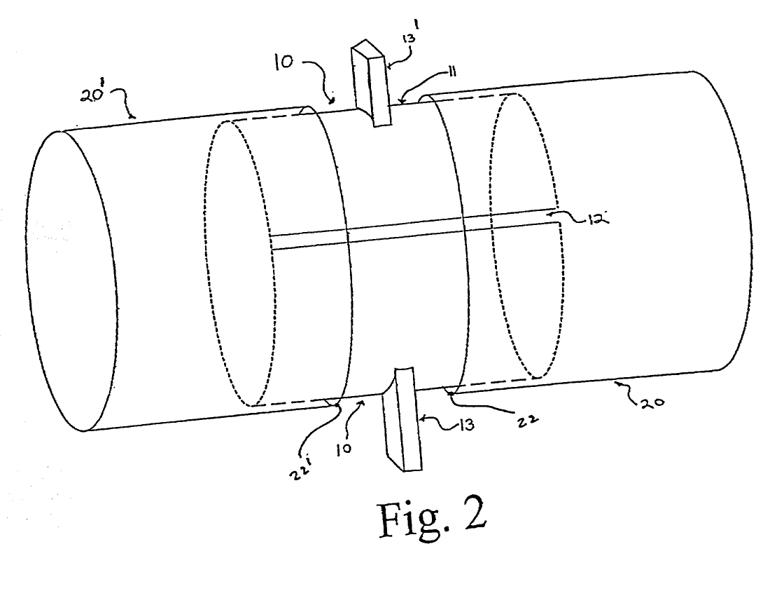

FIG. 2 illustrates the protective shield and coupling assembly 10 inserted into two conduits 20, 20′. The compression of the sleeve 11 caused the sleeve 11 to slide over itself starting at the split 12. This resulted in a reduction in sleeve 11 diameter. Once compressed, the coupling assembly 10 was partially inserted into two lengths of fiber optic conduit 20, 20′ and allowed to expand. FIG. 2 illustrates the coupled conduits 20, 20′ with the coupling assembly 10 partially inserted inside each conduit 20, 20′. When a preferred embodiment of the invention expands fully, the4 conduits 20, 20′ are coupled so as to be rodent proof. Upon complete insertion of the sleeve 11, the respective ends 22, 22′ of the conduits 20, 20′ will be adjacent to the guards 13, 13′. In one preferred embodiment of the invention, the corrosive, and damage resistant properties of the material comprising the split sleeve 11 are chosen to enable compression of the coupler by hand as well as enhance its function as a protective rodent proof shield.

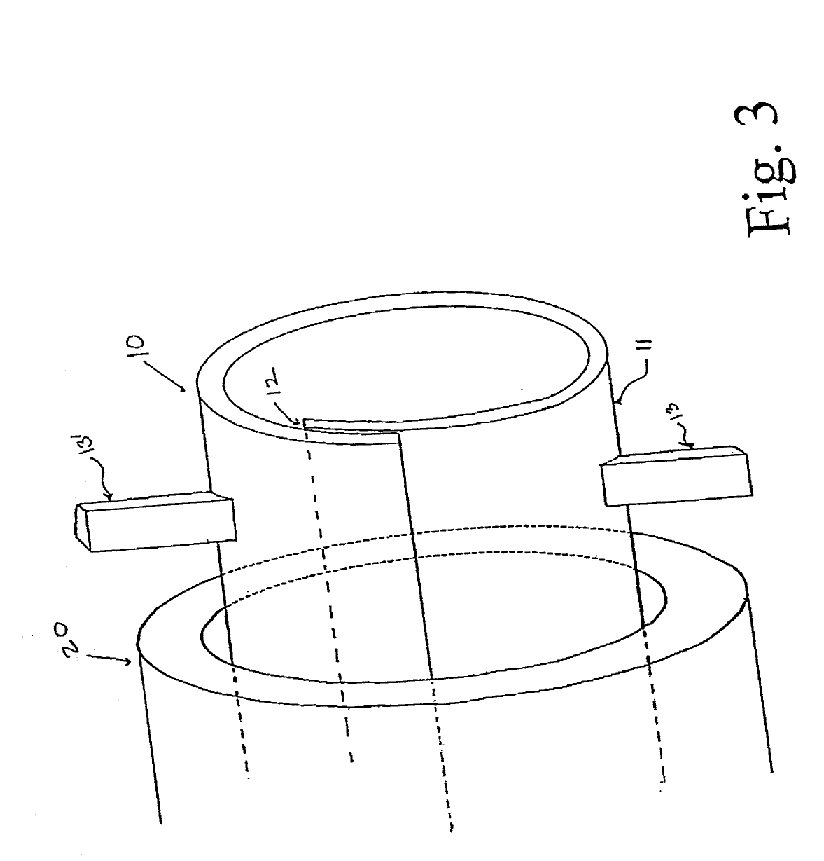

FIG. 3 illustrates the coupling assembly 10 in a partially coupled partially compressed state. The coupling assembly 10 has been inserted into one length of fiber optic cable conduit 20. The coupling assembly 10 is shown at a high level of compression within a length of fiber optic cable conduit 20. In this preferred embodiment, the guard is shown as two, three dimensional structures 13, 13′ radiating outward from the sleeve 11 at an angle of one hundred and eighty degrees from each other. In another embodiment, only one guard is used. In still another embodiment, more than two guards are present. In still yet another embodiment, the guards are set apart from each other at an angle of less than one hundred and eighty degrees. In addition, the guard 13 is shown as protruding above the outer most diameter of the fiber optic cable conduit 20. This ensures that the coupling joints may be visible no matter what method or type of fiber optic conduit installation is being performed. In another preferred embodiment of the invention the guard 13 is either mechanically attached or chemically bonded to the sleeve 11.

Thus the present invention provides an inexpensive, easy to use method of joining two conduits in a manner to prevent animals from obtaining access to the fiber optic bundles there within.

What is claimed is:

1. A protective shield and coupling assembly for use in connecting a first fiber optic cable conduit to a second fiber optic cable conduit, said shield and coupling assembly comprising:
a resilient split sleeve having a guard extending radially from said split sleeve,
wherein said split sleeve is compressible into a smaller compressed diameter for insertion into said fiber optic conduit and which is expandable so as to be substantially equal to the diameter of said fiber optic cable conduit once inserted.

2. The protective shield and coupling assembly of claim 1, wherein said sleeve is made of a ductile material being sufficiently resilient so as to be compressible by hand for insertion into said fiber optic cable conduit.

3. The protective shield and coupling assembly of claim 1, wherein said sleeve is made of a ductile material being sufficiently resilient so as to be compressible only by machine for insertion into said fiber optic cable conduit.

4. The protective shield and coupling assembly of claim 1, wherein said guard extends radially from said fiber optic cable conduit to indicate the region of a joint between pipe lengths.

5. The protective shield and coupling assembly of claim 2, wherein said guard is mechanically attached to said sleeve.

6. The protective shield and coupling assembly of claim 2, wherein said guard is chemically bonded to said sleeve.

7. The protective shield and coupling assembly of claim 2, wherein said ductile material and guard are corrosion and rodent proof.

8. The protective shield and coupling assembly of claim 5, wherein said ductile material and guard are corrosion proof and the guard is configured to encircle the sleeve so as to maintain the substantially cylindrical shape of the sleeve.

9. The protective shield and coupling assembly of claim 8, wherein the guard encircles the exterior of said sleeve, said guard being comprised of heavy gauge wire, wherein the terminal ends of the wire radially extend from said sleeve to indicate the region of a joint between pipe lengths.

10. The protective shield and coupling assembly of claim 9, wherein said sleeve is composed of low carbon steel with a rust proof coating.

11. A method of coupling together lengths of fiber optic cable conduit and protecting the enclosed fiber optic cable from destruction which comprises:
(a) rolling a sheet of resilient metal into a split sleeve;
(b) encircling said sleeve with a guard which extends radially from said split sleeve;
(c) compressing said split sleeve either by hand until the compressed diameter is suitably reduced for insertion into said fiber optic cable conduit;
(d) inserting one end of the compressed sleeve into said fiber optic cable conduit;
(e) reducing the compression being applied to the sleeve to allow the sleeve to expand to a diameter substantially equal to said fiber optic cable conduit; and
(f) repeating steps (a) through (e) for the unconnected region of the sleeve in order to couple together two lengths of fiber optic cable conduit.
